(19) United States
(12) Patent Application Publication
(10) Pub. No.: US 2009/0119334 A1
(43) Pub. Date: May 7, 2009

(54) Interleaving Ad Hoc and Structured Business Processes

(76) Inventors: Michael Ian Ahern, Brighton, MA (US); Ajamu Akinwunmi Wesley, Marlborough, MA (US); Michael C. Wanderski, Durham, NC (US); Michael Dennis Facemire, Pittsboro, NC (US)

Correspondence Address: Steven E. Bach Attorney at Law, 10 Roberts Road, Newtown Square, PA, 19073, US

(21) Appl. No.: 11/935,806

(22) Filed: Nov. 6, 2007

(51) Int. Cl. G06F 17/30

(52) U.S. Cl. 707/104.1; 707/100; 707/E17.005

(57) ABSTRACT

A system and method are provided for managing a workflow for a document. An electronic form is created for receiving data pertaining to a workflow. A content integration template locates and exposes data fields in the electronic form. A document workflow defines states of the document, transitions between states, and actions for each state.

### FIELD OF THE INVENTION

The invention relates to the field of workflow management and more particularly to an apparatus, method and program product for dynamically interleaving an ad hoc document and its associated lifecycle with structured business processes.

### BACKGROUND

It is estimated that approximately 80% of business is conducted using unstructured or semi-structure information, with 85% of data being held in unstructured forms, including e-mail, memos, letters, notes, faxes, phone calls, and paper documents. This unstructured data cannot be easily used or retrieved using automated processes. Further compounding this problem, the stockpile of unstructured and semi-structured data is doubling every six months. With so much unstructured data accumulating it should come as no surprise that white-collar workers now spend an estimated 30% to 40% of their working hours managing documents containing unstructured data, up from about 20% of their working hours in 1997. This avalanche of unstructured information has given rise to a perfusion of ad hoc and semi-structured workflows as companies and employees seek to streamline their work.

Transactional workflow systems, such as Business Process Choreographer or BPEL4J provide a means of describing structured business processes by providing a meta-model such as Business Process Execution Language (BPEL) for describing the workflow of activities in a business process. BPEL describes these activities as partner-links which are often, but not always, Web Services. Data returned from services can be used to decide the next course of action and/or be fed into other Web Service end-points. It is difficult to create a BPEL model of a workflow based on an ad-hoc workflow, because data from an ad hoc workflow is not easily extracted. Moreover, BPEL does not directly map to the state-based constructs of a document lifecycle.

Document Management Systems (DMS) provide a means to store, file, and retrieve electronic or scanned representations of paper documents. Often, these systems provide certain lightweight document centric workflow tasks such as check-in, versioning, and locking. However, a DMS is not readily adaptable to an ad-hoc workflow. While stored in the document manager, the data contained in the document is not generally accessible as a construct of a workflow system. For example, the “first name” field in a mortgage application in a DMS would be stored arbitrarily as a blob in the system along with the rest of the form. Thus, the data can not be used to track or determine a workflow.

Due to the limitations of existing systems, each document workflow entails a custom programming task, with a developer (or more often a group of developers) defining a means for storing and retrieving data from a document, exposing the document lifecycle, and so forth. Thus, a need exists for a way to interleave ad hoc processes with structured processes and to formalize these ad hoc processes. Moreover, the need for procedural programming logic and associated tooling should be minimized or avoided as much as possible.

### SUMMARY

A system and method are provided for managing a workflow for a document. An electronic form is created for receiving data pertaining to a workflow. A content integration template locates and exposes data fields in the electronic form. A document workflow defines states of the document, transitions between states, and actions for each state.

According to an exemplary embodiment of the invention, a document manager receives an electronic form with data pertaining to a workflow. The document manager extracts the data from the electronic form using a content integration template and instantiates an instance of a document centric workflow comprising one or more document states, actions for each state, and conditions for transition between states. At each state the document manager calls the actions for that state. In response to meeting conditions for transition, the document manager transitions between states.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of a system for managing a workflow for an ad-hoc document according to an exemplary embodiment of the invention;

FIG. 2 is a schematic showing management of a workflow for an ad-hoc document according to an exemplary embodiment of the invention;

FIG. 3 shows a document with workflow related data according to an exemplary embodiment of the invention;

FIG. 4 shows a content integration template according to an exemplary embodiment of the invention;

FIG. 5 shows annotations for interacting with document manager state according to an exemplary embodiment of the invention;

FIG. 6 shows annotations for evaluating conditional links using form data according to an exemplary embodiment of the invention;

FIG. 7 shows a workflow action according to an exemplary embodiment of the invention;

FIG. 8 is a block diagram of a workflow for an ad-hoc document according to an exemplary embodiment of the invention;

FIG. 9 is a flow diagram of a method for managing a workflow according to an exemplary embodiment of the invention.

### DETAILED DESCRIPTION

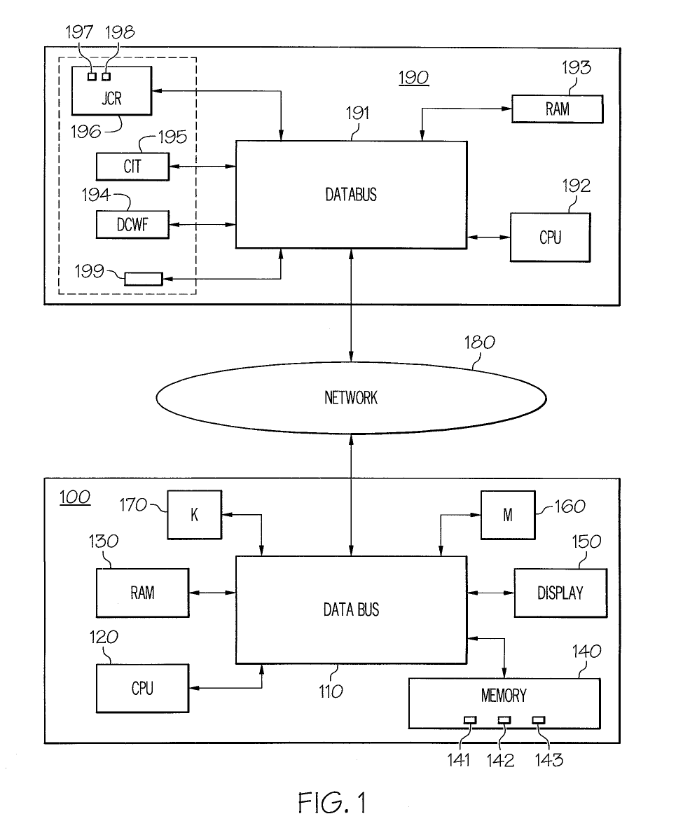

FIG. 1 shows a system 190 for managing a workflow of an ad-hoc document according to an exemplary embodiment of the invention. In the illustrated exemplary embodiment, the system comprises a processor 192 interconnected through a data bus 191 with a random access memory (RAM) 193, and one or more memories. The one or more memories may include for example a hard drive or various media drives, or an external memory device. A content repository 196, which may be, for example a java content repository (JCR), a content integration template (CIT) 195, a document centric workflow (DCWF) 194, and a document manager 199 are stored on the one or more memories. The document manager 199 may be, for example, a program of instruction adapted to be executed by the CPU 192 to integrate an ad-hoc document with a structured business process system.

The workflow management system 190 may be connected through a network 180, such as an intranet or the Internet to one or more user stations 100, which may be, for example, a personal computer having a data bus 110 interconnected with a central processing unit (CPU) 120, random access memory (RAM) 130, a memory 140, a display 150 a mouse 160, and a keyboard 170. User station 100 may be used for user initiated actions during document processing, such as loan approval or the like. Alternatively or additionally, user station 100 may be used to fill in user fillable fields in an electronic form.

Electronic form templates may be stored in the JCR 196 or, alternatively, may be made available from an internal memory or an external location. New templates also may be created by a user and stored to the JCR 196 or to another memory location. The electronic form template may be an electronic form in any of a number of form formats, such as workplace forms, XSPL, Xforms, adobe electronic forms, picture document file (pdf), and the like. In an exemplary embodiment an electronic form template includes fillable data fields. A form specific CIT 195 and a form specific DCWF 194 are also created and stored for each form template.

A user, administrator, or developer creates an electronic form (300 in FIG. 3) for receiving data pertaining to a workflow. The electronic form may be created using a template, as provided above, or by building a new form or importing a form. In an exemplary embodiment, the new electronic form 300 is configured to receive the data pertaining to a workflow in user fillable data fields. The workflow to which the data pertains may be a structured workflow or an ad-hoc workflow.

The user, administrator or developer also creates a CIT 195 enumerating the data fields on the electronic form 300 for data pertaining to the workflow. Alternatively, if the user is using a template from the content repository 196, an existing CIT 195 may be used. In an exemplary embodiment, a CIT 195 may be stored in the content repository 196 or other memory for each form template. The CIT 195 is used for locating and exposing the data fields in the electronic form 300 that contain data pertaining to the workflow.

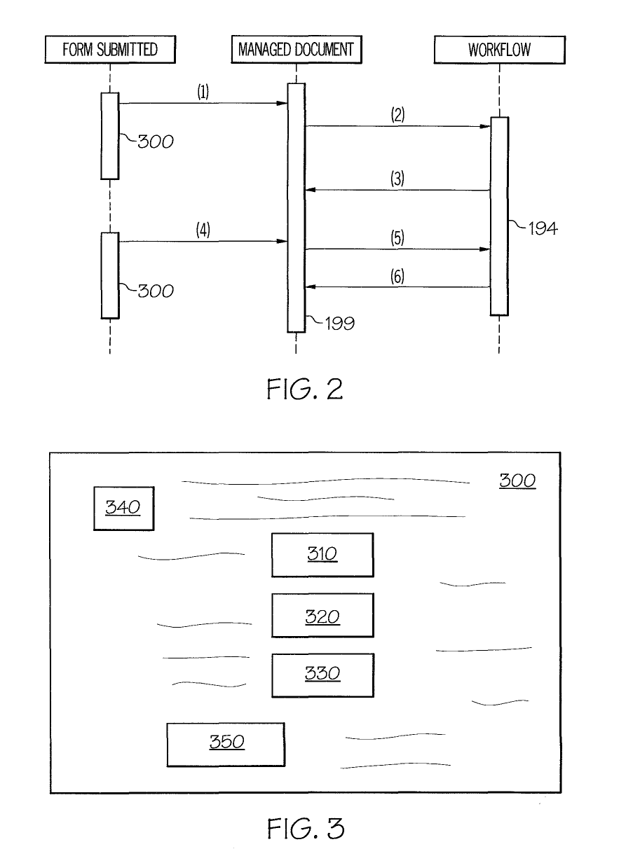

As shown in FIG. 2, the electronic form 300 is submitted to the document manager 199 by a user (step 1). The document manager 199 adds the electronic form 300 to the document repository 196. In this step, the document manager 199 also integrates the electronic form 300. That is, the document manager 199 makes the data in the fields enumerated by the CIT 195 available to the DCWF 194. This may be accomplished by, for example, assigning the data fields as named attribute nodes of the electronic document 300.

The DCWF 194 is a transactional workflow system that provides awareness of the state of the document in the work flow, conditions for transitions between states, and actions that are supposed to occur during each state. In an exemplary embodiment, the DCWF 194 is a document in Business Process Execution Language (BPEL), describing the activities of a business process as partner-links. These partner links are often Web Services, but may also be portal personalization information (PZN rules), timers, user augmented actions, and other information in a transition or state format. A BPEL engine or application can update the state of a state aware document using a state changer service. Thus, in an exemplary embodiment, the BPEL engine can call back to determine the state of a state aware document. This capability is used in the present invention to provide data from the form through the CIT to initiate and update the DCWF 194.

In an exemplary embodiment, the DCWF 194 is an intermediate file format that is later converted to an annotated BPEL document. This annotated BPEL document has all of the capabilities of a regular BPEL document, with calls back to the Document Lifecycle attributes of the document manager to update the user defined document “state”. In addition, the BPEL engine exposes a set of API's to the lifecycle manager, allowing, for example, pending-approval style workflows in which a reviewer manually chooses the next state for the document.

Referring again to FIG. 2, after the electronic form 300 is submitted, the document manager 199 instantiates an instance of a DCWF template associated with the electronic form 300 to create DCWF 194 (step 2). That is, the data from the CIT enumerated data fields are used to fill in the DCWF 194 and to define the initial state.

Through out the processing of the workflow, the BPEL engine updates the state of the electronic document 300 in the document manager 199 using a state changer service (step 3). For most workflows, this will happen multiple times during workflow processing. The “document state” itself is a document attribute that can be accessed by other document state awareness services.

In certain exemplary workflows, an electronic document may be edited and resubmitted (step 4). This resubmission may occur multiple times. For example, information in fillable fields may be corrected or added, and then the form may be resubmitted. Resubmission does not cause the creation of additional submission instances, but instead update the existing document instance. Through updates, the data contained in the document might change through out the processing of the DCWF.

In certain exemplary workflows, human tasks might be required. For example, an approval might be required in which a loan officer reviews a loan application document and manually enters a change of state command such as “approved” or “denied”. In these instances, the workflow system will wait for a use initiated action (step 5) before processing continues. Typically, user initiated actions will cause a change of state in the document manager 199.

Processing continues until the workflow has reached an end state. When the workflow reaches an end state, the document state is updated in the document manager 199 (step 6) to reflect the end state, and the state attribute remains accessible for the life of the document in the document management system.

FIG. 3 shows an exemplary electronic document 300 having user fillable data fields 310, 320, 330, 340, and 350. In an exemplary loan application form, these data fields may comprise a name 310 and contact information for a loan applicant (e.g., address 320 and phone number 330), social security number 340, gross income 350, and the like. The electronic form 300 is published on a web portal to be filled out by users, allowing the data entered onto the form to be managed.

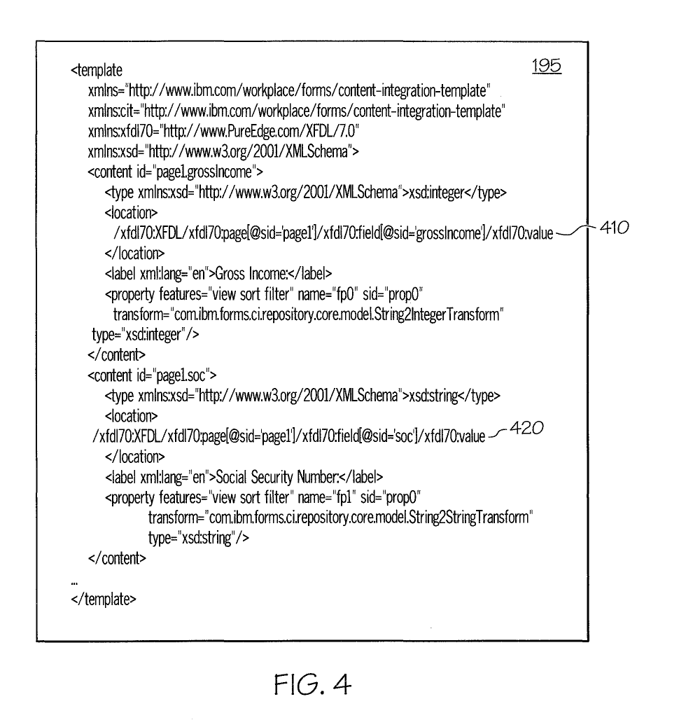

FIG. 4 shows a CIT 195 according to an exemplary embodiment of the invention. The CIT 195 provides the data fields or locations 410, 420 on the electronic form 300 where the gross income and social security number data, respectively can be found. This information is entered on the electronic form 300 by a user, for example a loan applicant. The information then can be used by the document manager 199 to process the electronic form 300 and update the state of DCWF 195.

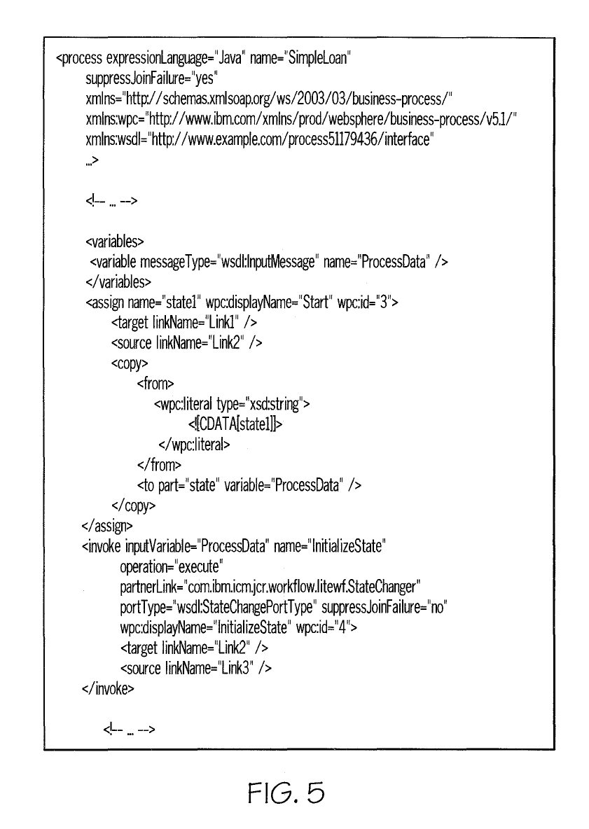

FIG. 5 shows BPEL annotations for interacting with the document manager 199 according to an exemplary embodiment for processing a loan application from an on-line loan form. As seen in FIG. 5, the BPEL annotations initialize the state to create a state awareness for the DCWF 195. Partner-links retrieve or send “state” information to/from the document manager 199. Processing steps or actions are performed for each state using the extracted data. Upon completion of all action associated with a state, call the state-changer to execute a change of state.

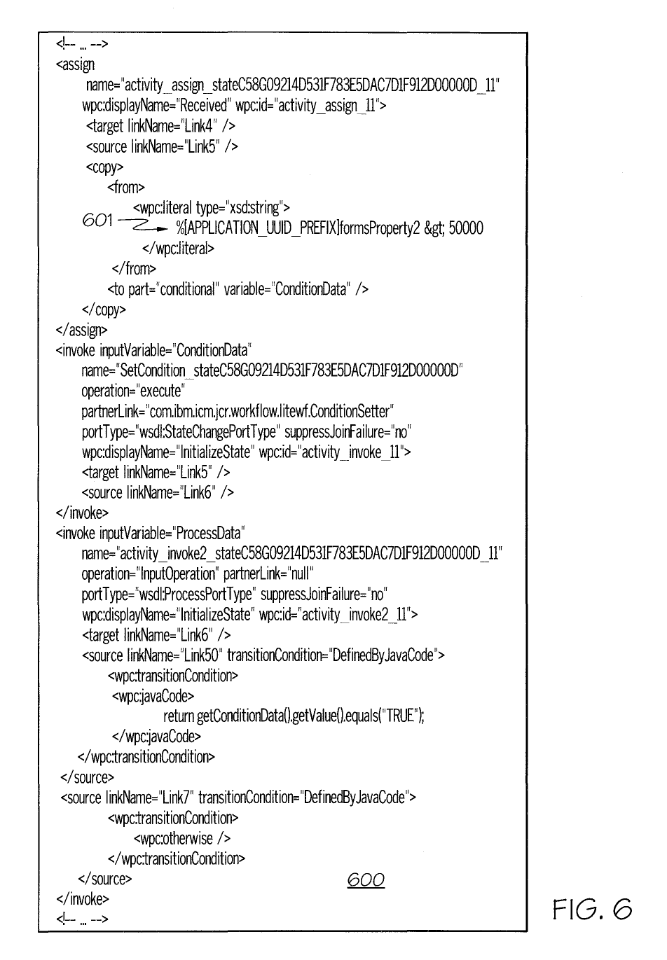

FIG. 6 shows annotations 600 for evaluating conditional links using data extracted from electronic form 300. As seen in this example, the extracted data is tested to determine whether or not the conditions for a transition of state are met. In the illustrated example, a predefined conditional comparison 601 compares an extracted value in the form of an Xpath expression. The extracted data in this example is for gross income, which is compared to a threshold value ($50,000 in the illustrated example) using a conditional comparison ((gt, or greater than). Thus, the gross income data is extracted and compared to a threshold. If the extracted value for gross income meets the threshold, then the state is changed to “pending review”. If the extracted value for gross income does not meet the threshold, then the state is changed to “rejected”.

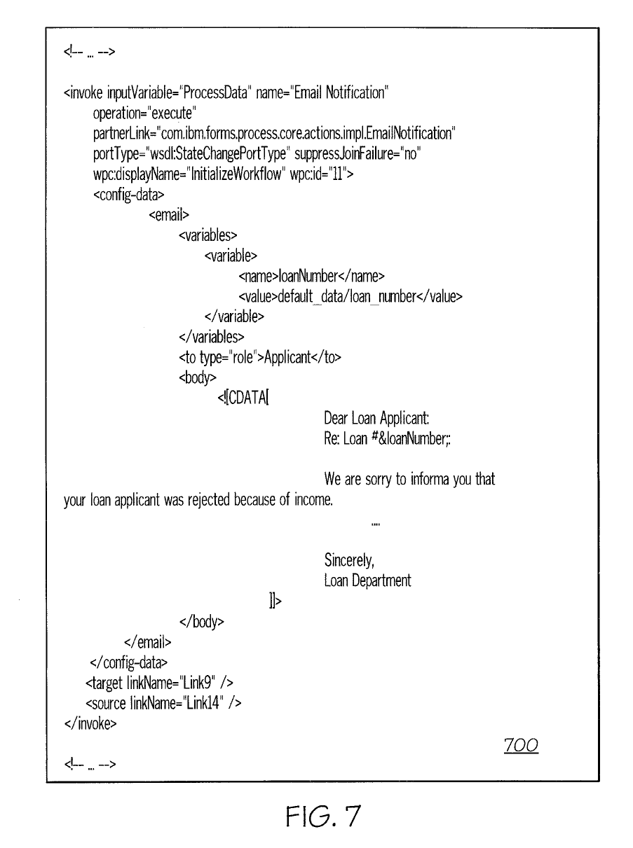

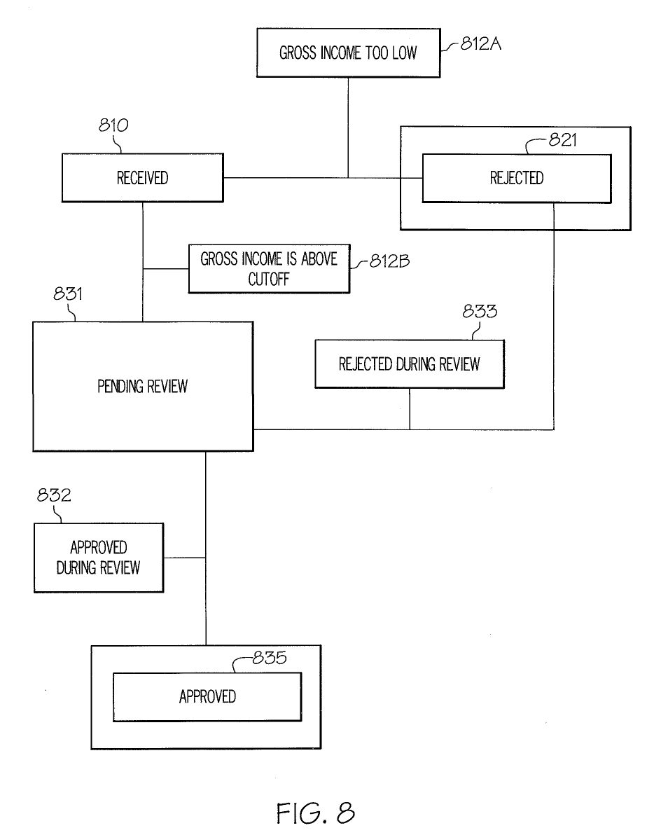

Each state of the DCWF 195 may require one or more actions such as sending a notification of approval or rejection to a loan applicant by automated mail, email or other communication form. Other actions may include comparisons of data to pre-determined thresholds, manipulation of data, retrieving data from other sources relating to identifiers extracted from the electronic form 300, and the like. FIG. 7 shows a document 701 created by a workflow action 700 notifying a loan applicant that the application was rejected because of income.

FIG. 8 is an exemplary DCWF 195. A loan applicant submits a loan application (e.g., electronic form 300) via Web, Fax, or the like (action 810). The submission of the application (action 810) triggers the document manager 199 through a partner-link to set the state to an initial “received” state 811. At the received state 811 a required action exists to compare the income data extracted from the submitted form 300 to a threshold value which may be set or calculated by a partner-link application (action 812).

If the extracted income data is less than the income threshold (action 812A), then the document manager 199 calls the state changer to change the state to “rejected” 821. At the rejected state a required action exists to automatically mail a rejection notice 701 to the applicant. If, however, the extracted income data is greater than the income threshold (action 812B), then the document manager 199 calls the state changer to change the state to “pending review” 831. At the pending review state 831, a user initiated review action is required. Thus, the state of the electronic form 300 will remain “pending review” while the extracted information is forwarded to a loan officer for review.

The loan officer may, for example, have a queue of applications for review. Once the loan officer has completed the review, he or she initiates an action to accept or reject the loan application (actions 832 and 833, respectively. This may be accomplished, for example, by selecting between these options from a menu, or another method indicating the user initiated action.

If the loan officer initiates an approval action (action 832), then the document manager 199 calls the state changer to change the state from “pending review” to “accepted”. The accepted state may, for example require a notification action (not shown). If, however, the loan officer initiates a “rejected” action (action 833), then the document manager 199 calls the state changer to change the state from “pending review” 831 to “rejected” 835, and a notification action is performed.

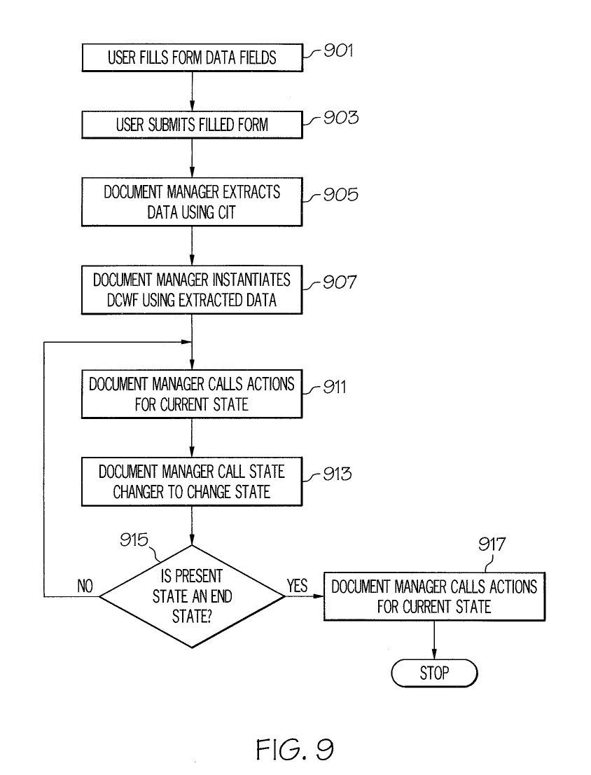

FIG. 9 is a flow diagram of a method for managing a work flow for a document, in the illustrated example, an unstructured document. The process begins with an electronic form 300 having fillable data fields published on a Web portal. The form could also be, for example an Xform or the like integrated with voice XML. In the example of an electronic form 300, a user fills in the fillable data fields (step 901) and submits the filled form 300 (step 903). The submission step (step 903) launches the document manager 199.

The document manager 199 calls the CIT 195 which extracts the data relating to the document process from the electronic form 300 (step 905). Thus, the data in the fillable fields, which was entered by the user in step 901, becomes exposed so that it may be used by the document manager 199 or other processing system or application. The extracted data may be used, for example, in various automated processes. In the example illustrated in FIG. 8, the applicant identification and gross income data are extracted from the fillable fields of the electronic form 300.

After extracting data from the electronic form 300 (step 905), the document manager 199 instantiates an instance of the DCWF 194 (step 907). For example, in the DCWF 194 illustrated in FIG. 8, the document manager 199 instantiates DCWF 194 at the “received” state, having the applicant identification and gross income data available for processing.

The document manager 199 then calls any actions for the current state (step 911). In the example illustrated in FIG. 8, the only action required at the “received” state is comparing the extracted gross income value with a threshold value that is either pre-defined or calculated, such as by calling a formula, or the like. The document manager will wait for a response from the called action. Depending upon the relative values of the extracted gross income data and the calculated or pre-defined income value, the comparison action will respond with “income is sufficient” or “income is too low”. If the response is “income is sufficient”, then the document manager calls the state changer, and the document state is changed to “pending review” (step 913).

After the change of state, the document manager determines whether or not the present state is an end state (step 915). If the present state is not an end state, such as for example, “pending review”, then the document manger calls the required actions for the new current state (in this example “pending review”) (step 911). At the “pending review” state there is a user initiated action of loan officer review. The information for the loan application is placed in a loan officer queue for review, and the process waits for the loan officer to enter an action, in this case either approved or rejected.

If the loan officer enters approved, then the document manager calls the state changer, and the document state is changed to “approved” (step 913). After the change of state, the document manager determines whether or not the present state is an end state (step 915). If the present state is an end state, such as for example, “approved”, then the document manager calls the required actions for the current end state of “approved” (step 917). In this example, the “approved” state might have required actions of notifying the applicant of approval and processing the loan. After the actions are completed for the end state, the process stops and the state remains at the end state. The end state remains available as an attribute for other state-aware processes or applications.

If the loan officer enters rejected, then the document manager calls the state changer, and the document state is changed to “rejected” (step 913). After the change of state, the document manager determines whether or not the present state is an end state (step 915). If the present state is an end state, such as for example, “rejected”, then the document manager calls the required actions for the current state (step 917). In this example, the “approved” state might have required actions of notifying the applicant of approval and processing the loan. After the actions are completed for the end state, the process stops and the state remains at the end state. The end state remains available as an attribute for other state-aware processes or applications.

If the response from the income comparison is “income is too low”, then the document manager calls the state changer, and the document state is changed to “rejected” (step 913). After the change of state, the document manager determines whether or not the present state is an end state (step 915). In this example “rejected” is an end state, and the document manager 199 then calls the required actions for the current end state (step 917). At the rejected state, there may be a required action of notifying the applicant. The document manager calls the action of notifying the applicant, and a notification is sent to the applicant. After the actions are completed for the end state, the process stops and the state remains at the end state. The end state remains available as an attribute for other state-aware processes or applications.

In an exemplary embodiment, decisions for a user initiated action may be tracked to model the user initiated action. Then, when the model is adequate, the model may be substituted for the user initiated action. For example, a model for loan officer review of a loan application might be developed from historical loan officer decisions. This model might be in the form of a formula, for example, fitting the decision pattern.

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system or device. For the purposes of this description, a computer-usable or computer readable medium may be any apparatus that can contain, store, communicate, propagate, or transport the program for use by or in connection with the instruction execution system, apparatus, or device.

The foregoing method may be realized by a program product comprising a machine-readable media having a machine-executable program of instructions, which when executed by a machine, such as a computer, perform the steps of the method. This program product may be stored on any of a variety of known machine-readable media, including but not limited to compact discs, floppy discs, USB memory devices, and the like. Moreover, the program product may be in the form of a machine readable transmission. Such as blue ray, HTML, XML, or the like.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk an optical disk. Current examples of optical disks include compact disk-read only memory (CD-ROM), compact disk-read/write (CD-R/W) and DVD.

The foregoing drawing figures and descriptions are for illustrative purposes and are not intended as limitations. Rather, variations and combinations of features are intended within the scope of the invention.

What is claimed is:

1. A system for managing a workflow for a document, comprising:
an electronic form for receiving data pertaining to a workflow;
a content integration template locating and exposing data fields in the electronic form; and
a document workflow defining states of the document, transitions between states, and actions for each state.

2. The system of claim 1, wherein the document workflow is an annotated BPEL document.

3. The system of claim 1, further comprising a document manager, wherein the content integration template is called by the document manager in response to receiving a completed electronic form.

4. The system of claim 3, wherein actions for each state of the document workflow are called by the document manager.

5. The system of claim 4, further comprising a state changer for transitioning between states of the document workflow, wherein the state changer is called by the document manager in response to completion of the actions for each state.

6. The system of claim 5 wherein the state changer is a BPEL annotation.

7. The system of claim 1 wherein the electronic form is published on a Web portlet.

8. A method for managing a workflow for a document, comprising the steps of:
creating a form application template;
creating a content integration template for said form application template;
defining a document centric workflow around said content integration template; and
publishing said form application template as a portlet.

9. The method of claim 8, wherein the form application template is an XSPL document.

10. The method of claim 8 wherein the document centric workflow is an annotated BPEL document.

11. A method for managing a workflow for a document, comprising the steps of:
receiving an electronic form with data pertaining to a workflow;
extracting the data from the electronic form using a content integration template;
instantiating an instance of a document centric workflow comprising one or more document states, actions for each state, and conditions for transition between states;
calling the actions for each state; and
in response to meeting conditions for transition, transitioning between states.

12. The method of claim 11, wherein the extracted data is used for one or more actions.

13. The method of claim 11, wherein the document workflow is an annotated BPEL document.

14. The method of claim 11, wherein the content integration template is called by a document manager in response to receiving a completed electronic form.

15. The method of claim 11, wherein actions for each state of the document workflow are called by the document manager.

16. The method of claim 11, wherein the transition conditions comprise completion of the actions for a state.

17. A program product for managing a workflow for a document comprising a computer readable medium having encoded thereon
machine executable instructions for creating a form application template;
machine executable instructions for creating a content integration template for said form application template;
machine executable instructions for defining a document centric workflow around said content integration template; and
machine executable instructions for publishing said form application template as a portlet.

18. The program product of claim 17 further comprising:
machine executable instructions for receiving an electronic form with data pertaining to a workflow;
machine executable instructions for extracting the data from the electronic form using a content integration template;
machine executable instructions for instantiating an instance of a document centric workflow comprising one or more document states, actions for each state, and conditions for transition between states;
machine executable instructions for calling the actions for each state; and
machine executable instructions for transitioning between states in response to meeting conditions for transition.

19. The program product of claim 17, wherein the conditions for transition comprise completion of the actions for a state.

20. The program product of claim 17, wherein the machine executable instructions for defining a document centric workflow around said content integration template comprise annotated BPEL.
